(19) United States
(12) Patent Application Publication
(10) Pub. No.: US 2013/0133240 A1
(43) Pub. Date: May 30, 2013

(54) LINE CONNECTOR APPARATUS AND METHOD

(71) Applicant: Karl Beitzel, Canton, OH (US)

(72) Inventor: Karl Beitzel, Canton, OH (US)

(21) Appl. No.: 13/306,139

(22) Filed: Nov. 29, 2011

(51) Int. Cl. A01K 83/00; F16L 5/00; F16B 45/00

(52) U.S. Cl. 43/43.16; 24/129 R

(57) ABSTRACT

A knotless connector includes a body that is generally planar, having a top surface and bottom surface oriented generally parallel to one another, and generally planar side surfaces intersecting the top and bottom surfaces at corners. The body may include a slot having an open end and a closed end, and an eyelet positioned adjacent to the slot including a bore and a radial opening providing access to the bore. The tail end of a line may be wrapped around the body to form a wrapped portion of the tail end, and the primary portion of the line may be wrapped over the wrapped portion, through the slot, and through the bore in the eyelet. The corners created by the intersecting surfaces of the body create friction points to help maintain the line on the connector with the use of knots.

### FIELD OF THE INVENTION

The apparatus and methods of this disclosure relate generally to line connectors and methods of connecting a length of line. More particularly, the apparatus and methods of this disclosure relate to line connectors and methods of connecting a length of line to another line or an object without tying knots.

### BACKGROUND OF THE INVENTION

In many instances it is necessary to connect a length of line or string to an object. For example, fishing requires the attachment of various and numerous objects to an end or intermediate portions of a fishing line. Other examples include camping, where knots are used to secure tent ropes to ground stakes, or covering boats or other large vehicles with tarps or other types of covers, where the tarps are tied down by ropes or lines secured to anchors. In any case, the connections must be secure and strong enough to resist forces acting on the line. Conventionally, and almost universally, one of a number of knots may be employed to secure the line to an object. While this approach can be effective in adequately securing the line to an object, it also suffers from several disadvantages.

Tying knots can be time consuming, especially where many knots are needed. For example, fishing can require securing a number of objects, such as, for example, hooks, weights, tackle, and the like, to a line. Depending upon changing conditions and success, or lack thereof, it may be necessary to change one or more of the objects secured to the line after a period of time. Thus, many knots may be tied in a single outing. Adding to the difficulty of tying the knots is the size of the objects and of the fishing line. It can be difficult to control the line and the object being connected to tie an intricate knot when both are small and difficult to handle. Additional challenges are experienced under circumstances where tension exists in the line while a knot is being tied. In addition, where the fishing hook or other tackle is secured to the middle of the line there is no ability to move the hook or other object up or down the line without removing them entirely and reattaching them to the line again with more knots.

Thus, there is a need for an apparatus and method for connecting objects to a line that alleviates one or more of the deficiencies discussed above.

### SUMMARY OF THE INVENTION

In general, a knotless connection assembly according to the present invention includes a connector having a body including a plurality of generally planar surfaces intersecting at a plurality of corners; and a line connected to the connector without the use of knots, the line including a tail end wrapped around said body to form a wrapped portion of the tail end, and a primary line overlapping at least part of the wrapped portion of the tail end.

In accordance with at least one aspect of the present invention, a fishing hook includes a knotless connection portion adapted to connect the fishing hook to a fishing line without the use of knots, a shaft, and a hook portion, the knotless connection portion including: a body that is part of said shaft, said body having top and bottom surfaces oriented generally parallel to one another and side surfaces extending between said top and bottom surfaces to define a thickness of said body; a slot having an open end and a closed end, and an eyelet positioned adjacent to said slot, said eyelet having a bore and a radial opening.

In accordance with at least one aspect of the present invention, a method of connecting a fishing hook to a line includes the steps of: positioning a fishing hook adjacent to a tail end of a fishing line, the fishing hook having a knotless connecting portion that is generally planar, with a top surface and a bottom surface oriented generally parallel to one another; wrapping the tail end of the fishing line around the knotless connecting portion of the fishing hook to form a wrapped portion of the fishing line; and wrapping a primary line that extends back to the fishing rod over the wrapped portion of the fishing line.

### BRIEF DESCRIPTION OF THE DRAWINGS

For a full understanding of the apparatus and methods of the present disclosure reference should be made to the following detailed description and the accompanying drawings, wherein:

FIG. 1 is a top view of a knotless connector for securing two lines together according to the concepts of the present disclosure.

FIG. 2 is a top view of another embodiment of a knotless connector for securing two lines together according to the concepts of the present disclosure.

FIG. 3 is a top view of another embodiment of a knotless connector for securing two lines together according to the concepts of the present disclosure.

FIG. 4 is a top view of another embodiment of a knotless connector for securing two lines together according to the concepts of the present disclosure.

FIG. 5 is a top view of a knotless connecter for securing an object to a line according to the concepts of the present disclosure.

FIG. 6 is a top view of a fishing hook including a knotless connector portion for securing a fishing line thereto according to the concepts of the present disclosure.

FIG. 6A is an enlarged top view of the knotless connector portion of the fishing hook of FIG. 6.

FIG. 7 is a top view of another embodiment of the fishing hook having a knotless connector portion for securing a fishing line thereto according to the concepts of the present disclosure.

FIG. 8 is a top view of another embodiment of the fishing hook having a knotless connector portion for securing a fishing line thereto according to the concepts of the present disclosure.

FIG. 9 is a top view of another embodiment of the fishing hook having a knotless connector portion for securing a fishing line thereto according to the concepts of the present disclosure.

FIG. 10 is a top view of another embodiment of the fishing hook having a knotless connector portion for securing a fishing line thereto according to the concepts of the present disclosure.

FIG. 11 is a top view of another embodiment of the fishing hook having a knotless connector portion for securing a fishing line thereto according to the concepts of the present disclosure.

FIG. 12 is a top view of another embodiment of the fishing hook having a knotless connector portion for securing a fishing line thereto according to the concepts of the present disclosure.

FIG. 13 is a top view of another embodiment of the fishing hook having a knotless connector portion for securing a fishing line thereto according to the concepts of the present disclosure.

FIG. 14 is a top view of a fishing accessory including a knotless connecting portion according to the concepts of the present disclosure.

FIG. 15 is a top view of another fishing accessory including a knotless connecting portion according to the concepts of the present disclosure.

FIG. 16 is a top view of another fishing accessory including a knotless connecting portion according to the concepts of the present disclosure.

FIG. 17 is a top view of another fishing accessory including a knotless connecting portion according to the concepts of the present disclosure.

FIG. 18 is a top view of another fishing accessory including a knotless connecting portion according to the concepts of the present disclosure.

FIG. 19 is a top view of another fishing accessory including a knotless connecting portion according to the concepts of the present disclosure.

FIG. 20 is a top view of another fishing accessory including a knotless connecting portion according to the concepts of the present disclosure.

FIGS. 21A-F are schematic views showing the sequence of securing the fishing hook including the knotless connecting portion of FIG. 6 to a fishing line without the use of a knot.

FIG. 22 is a top view of another embodiment of a fishing hook including an alternate knotless connecting portion according to the concepts of the present disclosure.

FIGS. 23A-F are schematic views showing the sequence of securing the fishing hook including the knotless connecting portion of FIG. 23 to a fishing line without the use of a knot.

FIG. 24 is a top view of another embodiment of a fishing hook including the knotless connecting portion of FIG. 22.

FIG. 25 is a top view of a fishing accessory including the knotless connecting portion of FIG. 22.

FIG. 26 is a top view of another fishing accessory including the knotless connecting portion of FIG. 22.

FIG. 27 is a top view of another fishing accessory including the knotless connecting portion of FIG. 22.

### DETAILED DESCRIPTION OF THE ILLUSTRATIVE EMBODIMENTS

Various embodiments of the apparatus and methods of the present disclosure will be discussed and disclosed herein. Like components in the various embodiments, as show in the figures, will be numbered with like numerals.

The knotless connectors or connecting portions as shown in the figures and described herein are adapted to be secured to one or more lines without the use of knots. Accordingly, the term knotless, as used throughout this disclosure, should be interpreted as meaning without or devoid of knots. The connectors or connecting portions of this disclosure are adapted to be connected to a line without the use of knots by virtue of the shape and geometry of the connecting portion. It will be appreciated by those skilled in the art that while a number of embodiments are disclosed, the shape and geometry of the connectors and/or connecting portions can be utilized in a wide variety of objects and industries to provide for knotless connection of an object to a line or a first line to a second line.

The term line as used in this disclosure should be interpreted to mean any cord, string, rope, fishing line, or other suitable length of flexible material. Fishing line will be discussed with respect to particular embodiments that include fishing hooks and attachments, but it will be apparent to those skilled in the art that the apparatus and methods of the present disclosure are not limited to a particular type of line.

The knotless connectors and devices incorporating knotless connecting portions according to this disclosure have a shape or profile that provides a plurality of friction points around the circumference thereof. In one or more embodiments, a knotless connector or a device including a knotless connecting portion according to the concepts of the present disclosure may be formed from flat sheet metal, and may therefore have opposing planar surfaces spaced from one another by a thickness. In other embodiments, a knotless connector or a device including a knotless connecting portion according to the concepts of the present disclosure may have a sectional profile that is a square, rectangle, hexagon, or any other shape that provides corners or friction points. It is also contemplated that raised ribs may be provided on a round shaft to create the desired friction points. In certain embodiments, the surface of the knotless connector or a device having a knotless connecting portion may have a textured surface.

In one or more embodiments, the metal, and the resulting knotless connectors, may have a thickness of greater than 0.003 inches, in other embodiments greater than 0.010 inches, in other embodiments greater than 0.100 inches, in yet other embodiments greater than 1.000 inches, and in still other embodiments greater than 10.00 inches. In the same or other embodiments, the metal, and the resulting knotless connectors, may have a thickness of less than 12.00 inches, in other embodiments less than 1.000 inches, in other embodiments, less than 0.100 inches, in yet other embodiments less than 0.010 inches, and in still other embodiments less than 0.009 inches. In certain embodiments where a fishing hook is provided with a knotless connecting portion, the metal, and the resulting knotless connectors, may have a thickness of between approximately 0.010 and 0.030 inches. In a particular embodiment where a fishing hook is provided with a knotless connecting portion, the metal, and the resulting knotless connectors and fishing hooks, may have a thickness of approximately 0.020 inches (24 gauge sheet metal). In one or more embodiments, the thickness of the metal may be at least three times the diameter of the line that is to be connected thereto. Any metal known to those skilled in the art and suitable for the intended use of the knotless connector may be employed.

In certain embodiments, a knotless connector or a device including a knotless connecting portion may be cut from the sheet metal stock using laser cutting techniques. As will be appreciated, laser cutting of the knotless connector allows for efficient and accurate production of a high number of connectors. Creation of connectors, fishing hooks, fishing accessories, and other objects within the scope of the present disclosure from sheet metal may result in edges or corners 102 where the object is cut from the sheet metal. It is also contemplated that the knotless connectors and/or devices including knotless connecting portions may be formed using stamping, photo etching, chemical etching, wire EDM, extrusion slices, CNC routing, plasma cutting, bandsaw, and other known manufacturing methods, depending upon the application and materials used.

In one or more embodiments, the corners 102 of the knotless connectors, fishing hooks, or other objects including knotless connecting portions may be rounded or chamfered to decrease the sharpness of the corners. In certain embodiments, the corners 102 may be chamfered at specific locations of the object where a line may contact or engage the object to form a knotless connection. The chamfered corner 102 may reduce the chances of the line being cut or damaged under tension by eliminating extremely sharp corners. In one or more embodiments, the entire periphery of the knotless connector or device including a knotless connecting portion includes a corner 102 or edge.

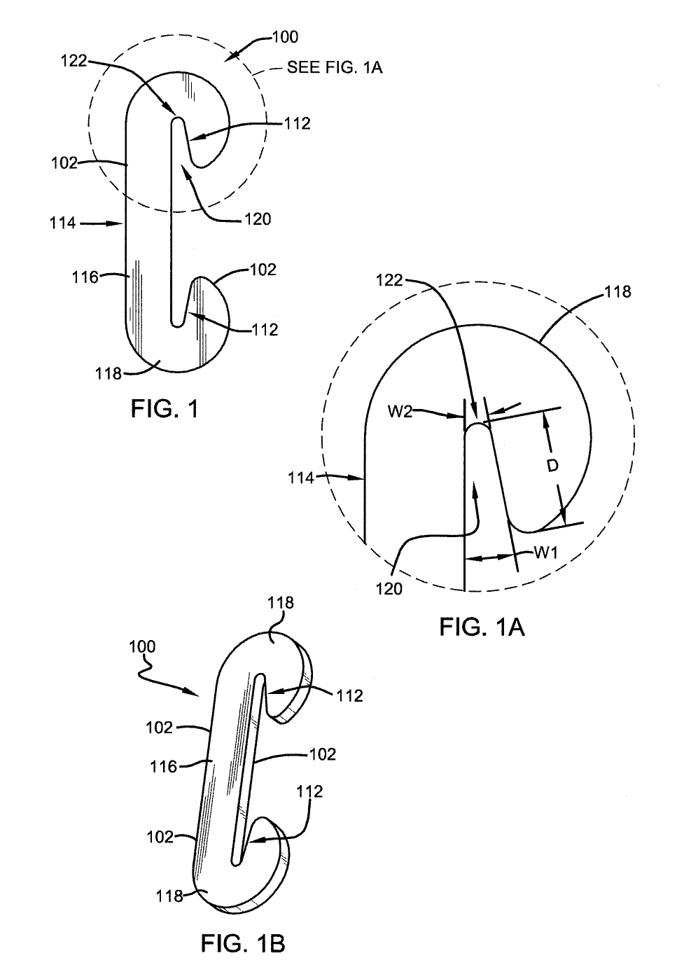

Referring now to FIGS. 1, 1A, and 1B a knotless connector is shown and is generally indicated by the numeral 100. Connector 100 is adapted to secure two lines together, and therefore includes two line attachment slots 112 in a body 114, the line attachment slots 112 having substantially similar geometry and dimensions, but oriented in opposite directions. Body 114 of connector 100 includes a central portion 116 and hook portions 118 on each end of the central portion 116. The hook portions 118 of connector 100 extend in a common direction from the central portion 116.

Each of the slots 112 is formed at the intersection of a hook portion 118 with the central portion 116. Each slot has an open end 120 and a closed end 122, and a depth D equal to the distance between the open end 120 and the closed end 122. In certain embodiments, the slots 112 may have a width that decreases progressively from the width W₁ of open end 120 to the width W₂ at closed end 122. In one or more embodiments, the surface of slots 112 at closed end 122 may be rounded or radiused.

In certain embodiments, the slots 112 may be provided with specific dimensions relative to the line 124 that is to be attached to the connector 100 to improve the performance of the connector and the connection between the connector 100 and the line 124. In one or more embodiments, the slots 112 may have a width W₂ that is less than approximately 3.0 times the diameter of the line 124, in other embodiments less than approximately 2.5 times the diameter of the line 124, and in yet other embodiments less than approximately 2.0 times the diameter of the line 124. In the same or other embodiments, the slots 112 may have a depth D that is greater than approximately 2.0 times the diameter of the line 124, in other embodiments greater than approximately 2.5 times the diameter of the line 124, and in still other embodiments greater than approximately 3.0 times the diameter of the line 124.

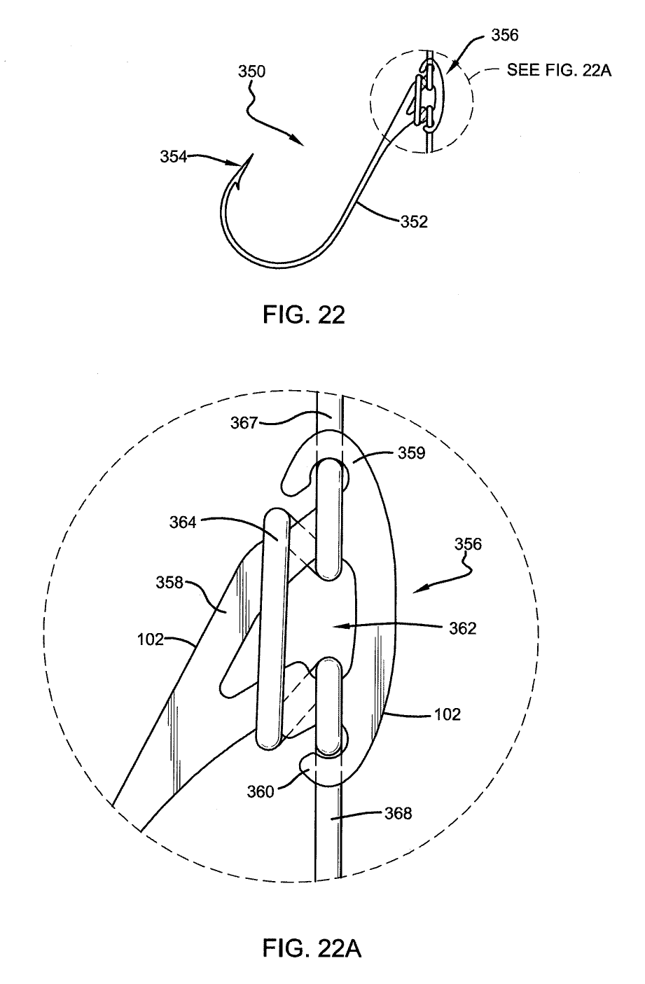

To form a connection between the connector 100 and the line 124, the tail end 126 of the line 124 is wrapped around the central portion 116 of the connector 100, with successive wraps approaching the closed end 122 of the slot 112 (see FIGS. 22A-22C). The primary line 128 is then pulled over the wrapped portion of the tail end 126 and through the slot 112 (see FIG. 22E), with tension on the primary line acting on the wrapped portion of the tail end to maintain a secure connection. The tail end 126 may be wrapped any number of times around central portion 116 of body 114. In certain embodiments, the tail end 126 of the line 124 may be wrapped around central portion 116 of connector 100 at least two times, in other embodiments at least three times, and in yet other embodiments at least four times.

As will be appreciated by those skilled in the art, connector 100 allows for knotless connection of two lines, each line being secured to connector 100 at a slot 112 without the use of knots. The corners 102 of the connector 100 created by manufacturing the connector 100 from flat sheet metal create a plurality of friction points where the tail end 126 of line 124 wraps around the corners 102. These friction points at the corners 102 substantially increase the strength of the knotless connection between the connector 100 and the line 124. Conversely, a round or otherwise radiused hook or connector would not provide sufficient friction between the line 124 and the connector 100 for a knotless connection to be effective. For example, by wrapping the tail end 126 of the line 124 around the central portion 116 of the connector 100 twice, twelve friction points are created, each of these friction points adding strength to the knotless connection. With enough wraps, and friction points, the knotless connection becomes stronger than the line 124. Additionally, the tail end 126 of the line 128 is compressed under the stress of the primary line 128, which creates increased friction between the tail end 126 and the connector 100 as tension in the primary line 128 increases. The friction points created by corners 102, and the overlapping of the tail end and primary portion of the line are features that may apply to any of the alternative embodiments disclosed.

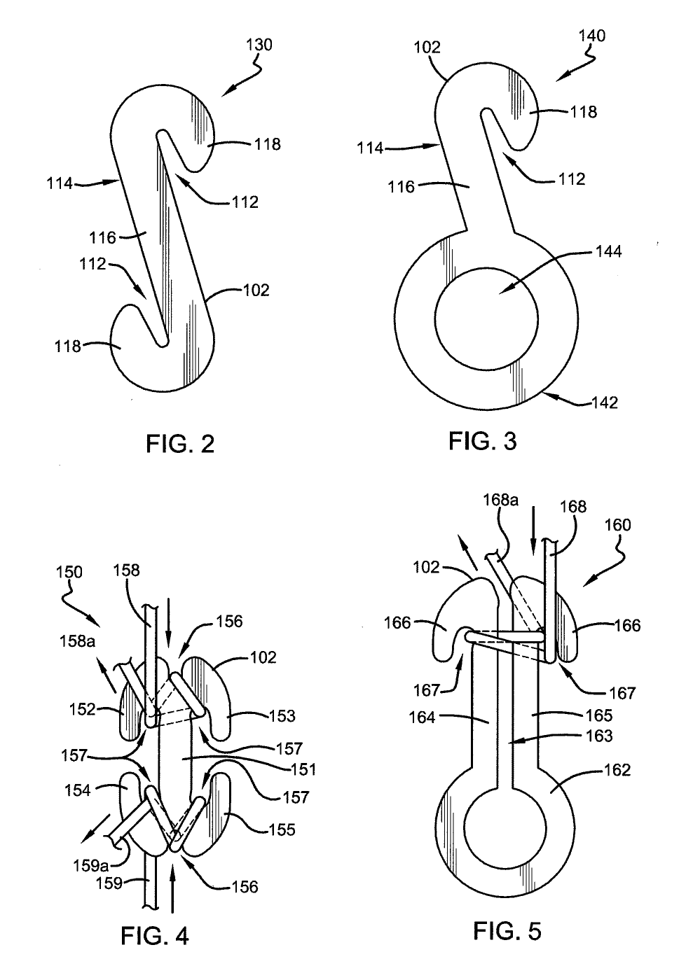

Referring now to FIG. 2, another embodiment of a knotless connector is shown, and is indicated generally by the numeral 130. Connector 130 is substantially similar to connector 100 and like features are therefore numbered accordingly. The only significant difference between connector 130 and connector 100 is the direction that the hook portions 118 extend from central portion 116. As discussed above, the hook portions 118 of connector 100 extend in a common direction, whereas the hook portions 118 of connector 130 extend in opposing directions.

Referring now to FIG. 3, another embodiment of a knotless connector is shown, and is indicated generally by the numeral 140. Connector 140 includes only a single hook portion 118, and in place of the second hook portion 118 of connector 100, an eyelet 142 is provided. Eyelet 142 includes a bore 144 therethrough, and is adapted to facilitate the attachment of various terminal tackle items, such as swivels, clips, lures, split rings, and the like.

Referring now to FIG. 4, another embodiment of a knotless connector is shown, and is indicated generally by the numeral 150. Connector 150 is a double ended connector for constant tension conditions. The connector 150 may be used to connect a single line into a loop, or join two separate lines. As shown in FIG. 4, the connector 150 includes a central shaft 151 with first and second arms 152, 153 extending from one end of the shaft 151, and third and fourth arms 154, 155 extending from the other end of the shaft. A notch 156 is provided at the distal ends of the shaft 151. The intersection of each of the arms 152, 153, 154, and 155 with the shaft 151 forms a recess 157. The lines 158 and 159 may be wrapped around the, shaft 151 and the arms 152, 153, 154, and 155 in a variety of patterns or formations, so long as the tail end of each of the lines 158a and 159a is trapped beneath the primary portion of the line so that, under tension, the primary line applies pressure, and friction, the to the tail end.

Referring now to FIG. 5, another embodiment of a knotless connector is shown, and is indicated generally by the numeral 160. Connector 160 includes a loop end 162 and a slot 163 formed between two shafts 164, 165. An arm 166 extends outwardly, away from the slot 163, from the top of each shaft. The intersection of each arm 166 with the shafts 164 and 165 forms a recess 167. The slot 163 allows connection of items having a closed loop, such as many lures. The closed loop is fed through the slot 163 into the loop end 162. When a line 168 is secured around the tops of shafts 164 and 165, and arms 166, the slot 163 is closed, which keeps the connector from disengaging from the closed loop. The line 168 may be wrapped around the shafts 164 and 165 and arms 166, and optionally through the slot 163, in a variety of patterns or formations. As shown in FIG. 5, the tail end of the line 168a passes behind the arm 166 of top shaft 165, over shaft 165 and through slot 163, around shaft 164, through slot 163 again and under shaft 165, and the primary line then passes over arm 166 of shaft 165. Alternative wrapping configurations will be appreciated by those skilled in the art.

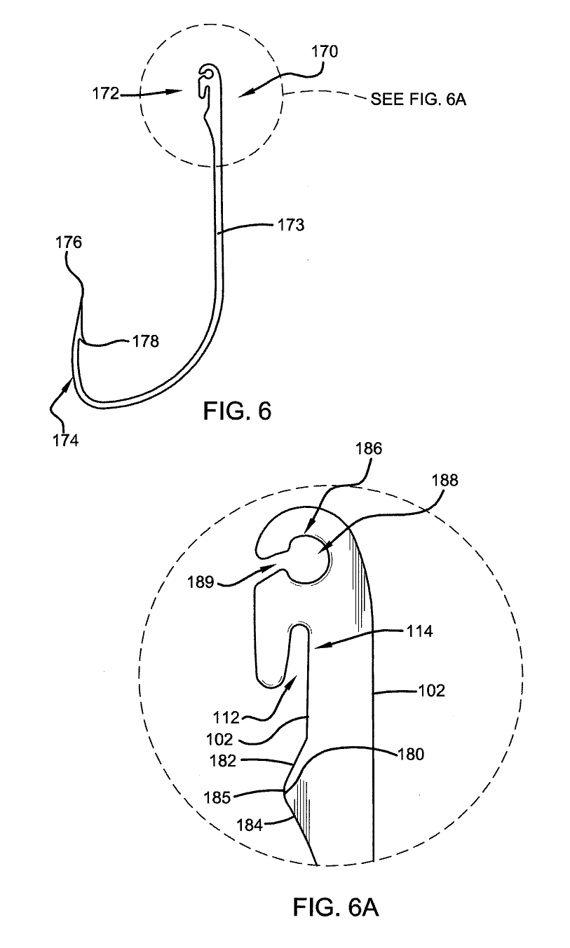

Referring now to FIGS. 6 and 6A, a fishing hook including a knotless connector portion is shown and is generally indicated by the numeral 170. In addition to the knotless connector portion 172, the fishing hook 170 includes a generally linear shaft 173 and a curved hook 174 with a pointed end 176 and a barb 178, as is well known to those skilled in the art. Connecting portion 172 includes a slot 112, as described above with respect to connector 100. In one or more embodiments, fishing hook 170 may also include a projection 180 extending adjacent to slot 112 and having angled surfaces 182 and 184 that meet at a point 185. Projection 180 helps to maintain a line in the desired location, and prevents the line, once wrapped around the fishing hook 170, from sliding toward hook 174. In certain embodiments, fishing hook 170 further includes an eyelet 186 positioned in body 114 of connecting portion 172 on a side opposite hook 174. Eyelet 186 may include a bore 188 therethrough, and a radial opening 189 in body 114 to provide access to bore 188.

With reference to FIGS. 22A-22F, a method of connecting the fishing hook 170 to a line 190 will be described. Line 190 includes a tail end 192 and a primary line 194. Tail end 192 is wrapped around body 114 adjacent to and/or partially within slot 112 (FIGS. 22A-22C). The primary line 194 is then wrapped to extend in the direction of the projection 180 (FIG. 22D). The primary line 194 is next pulled through the slot 112 over the wrapped portions of tail end 192, over a portion of body 114, and then back through the bore 188 in eyelet 186 (FIG. 22E). The radial opening 189 allows for the primary line 194 to be positioned through eyelet 186 without having to thread the line through the bore 188.

Passing the primary line 194 through the bore 188 of the eyelet 186 ensures that a minimal amount of tension is applied to the portion of the primary line 194 below eyelet 186, even where no tension is acting on the primary line 194 above the eyelet. Therefore, the knotless connecting portion 172 provides a secure attachment between the fishing hook 170 and the line 190 both in the presence of tension in the line, and without tension in the line. In one or more embodiments, the tail end 192 may also be routed through bore 188 of eyelet 186 in a manner similar to primary line 194 (FIG. 22F).

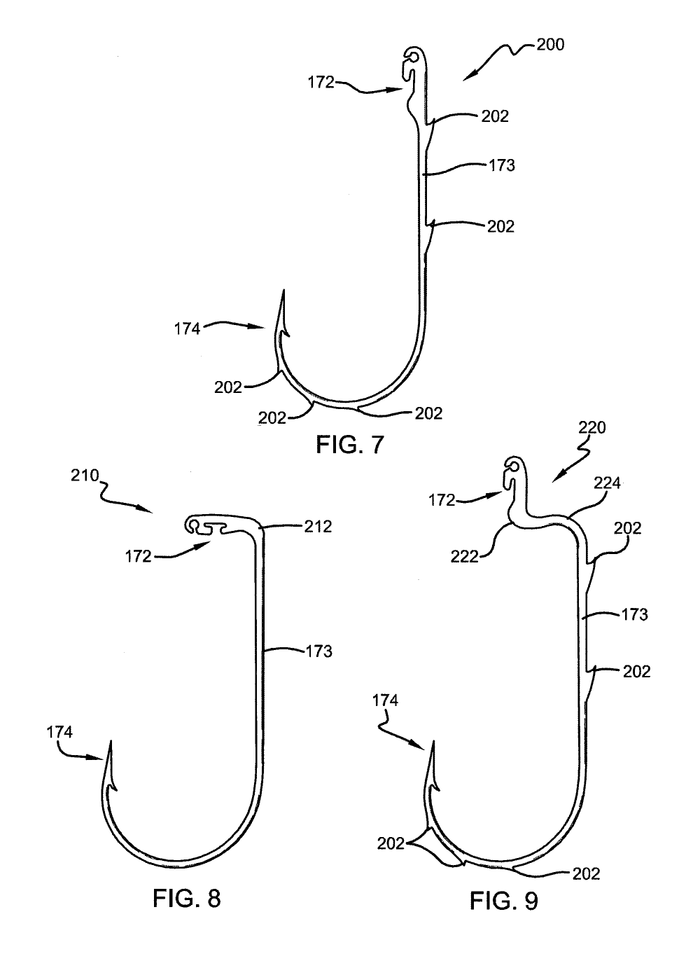

Referring now to FIG. 7, another embodiment of a fishing hook is shown, and is generally indicated by the numeral 200. Fishing hook 200 is substantially similar to fishing hook 170, and like parts are numbered accordingly. Thus, fishing hook 200 includes a knotless connecting portion 172, a shaft 173, and a hook 174. The only significant difference between fishing hook 200 and fishing hook 170 is that fishing hook 200 includes a plurality of pointed barbs 202 extending from the shaft 173 and the hook 174. The pointed barbs 202 assist in retention of live or plastic baits. In addition, the pointed barbs 202 help to keep the hook from walking out of a fish's mouth.

Referring now to FIG. 8, another embodiment of a fishing hook is shown, and is generally indicated by the numeral 210. Fishing hook 210 is also substantially similar to fishing hook 170. Thus, fishing hook 200 includes a knotless connecting portion 172, a shaft 173, and a hook 174. The shaft 173 of fishing hook 210 also includes a generally orthogonal corner 212 below the knotless connecting portion 172. Knotless connecting portion 172 is therefore oriented generally horizontally, or generally perpendicular to shaft 173, by virtue of corner 212. Fishing hook 210 may be referred to as a jig style hook.

Referring now to FIG. 9, another embodiment of a fishing hook is shown, and is generally indicated by the numeral 220. Fishing hook 220 is substantially similar to fishing hook 200. Thus, fishing hook 220 includes a knotless connecting portion 172, a shaft 173, a hook 174, and a plurality of pointed barbs 202. Additionally, fishing hook 220 includes a first bend 222 below knotless connecting portion 172, and a second bend 224 spaced further down shaft 173. Each of the bends 222, 224 forms an approximately right angle, with the bends opposing one another. Thus, knotless connection portion 172 is oriented generally vertically, or generally parallel to shaft 173, and is displaced horizontally from the rest of shaft 173. The offset provided in fishing hook 220 allows for a plastic worm to be hooked on the shaft in a manner that is said to appear more realistic and natural.

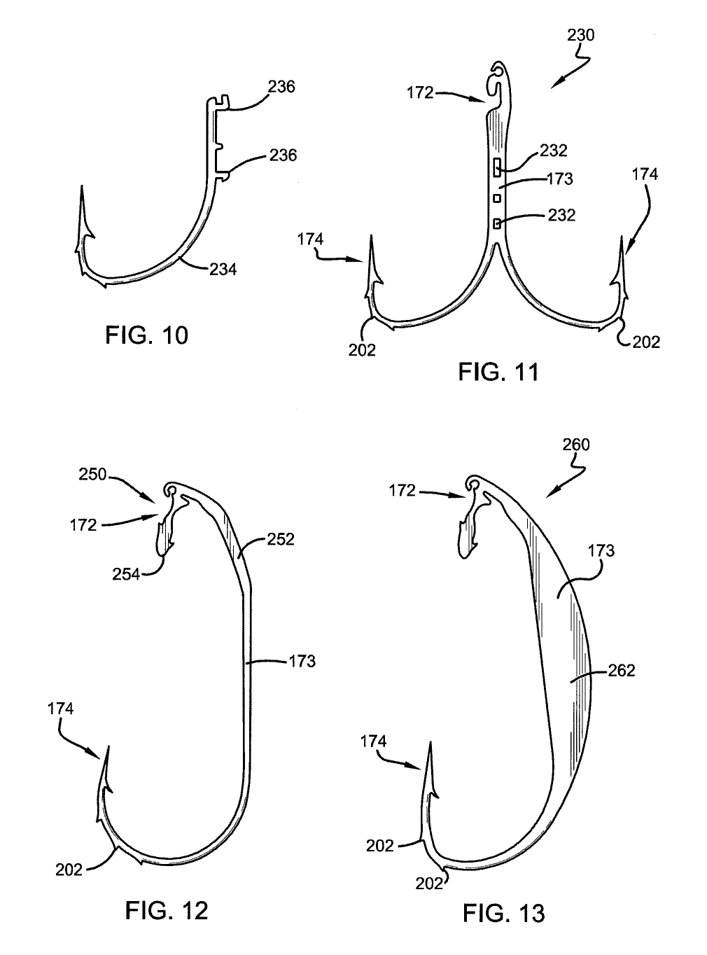

Referring now to FIGS. 10 and 11, another embodiment of a fishing hook is shown, and is generally indicated by the numeral 230. Fishing hook 230 is similar to fishing hook 200 and includes a knotless connecting portion 172, a shaft 173, and a pair of hooks 174 extending from a bottom of shaft 173 in opposing directions. Each of the hooks 174 includes a plurality of barbs 202. The shaft 173 includes a plurality of holes 232. A third hook 234 (FIG. 10) may include a plurality of projections 236 adapted to be received in the holes 232. In this way, a tree hook treble assembly may be formed without soldering.

Referring now to FIG. 12, another embodiment of a fishing hook is shown, and is generally indicated by the numeral 250. Fishing hook 250 is similar to fishing hook 200, and like parts are numbered accordingly. Fishing hook 250 includes a knotless connecting portion 172, a shaft 173, and a hook 174. Additionally, shaft 173 includes a curved portion 252 below knotless connecting portion 172. As a result of the curved portion 252, the knotless connecting portion 172 is oriented at an angle relative to shaft 173 and is positioned over hook 174. A prong 254 extends from the body portion 114 of knotless connecting portion 252. Prong 254 may be provided in any desired form, and in particular embodiments may be shaped like a fish. The prong 254 helps to maintain plastic baits on the hook. The end of the plastic bait may be pierced with the prong 254, and the hook 174 then set into the bait. This method saves time and is less complicated than traditional hooks. Additionally, the hook can be manufactured as a single piece including the prong 254.

Referring now to FIG. 13, another embodiment of a fishing hook is shown, and is generally indicated by the numeral 260. Fishing hook 260 is similar to fishing hook 250. Fishing hook 260 includes a knotless connecting portion 172, a shaft 173, a hook 174, and a plurality of barbs 202 extending from the hook 174. At least a portion of the shaft 173 of fishing hook 260 has a fin 262 with an enlarged width, thereby adding weight to the fishing hook. In addition, the fin 262 helps to add stability to the hook 260 and causes the bait to swim straighter in the water.

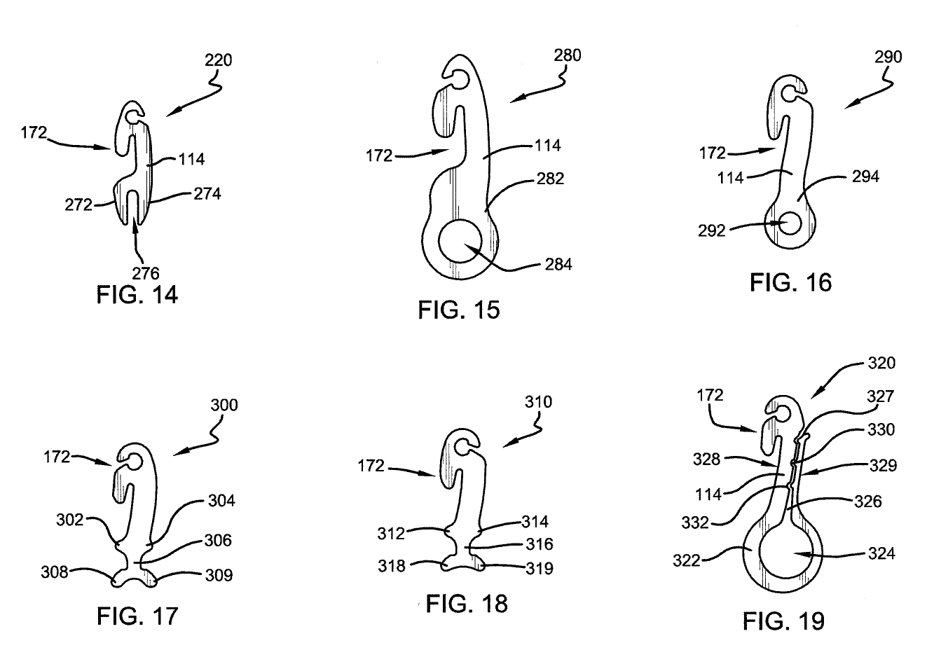

Referring now to FIG. 14, a fishing accessory is shown and is generally indicated by the numeral 270. Fishing accessory 270 includes a knotless connecting portion 172 as described above with respect to fishing hook 170. In addition, fishing accessory 270 includes first and second extensions 272 and 274 extending from a body 114 of the accessory. First and second extensions 272, 274 are spaced from one another to form a recess 276. The recess 276 is adapted to receive other objects for connection to the accessory 270. For example, traditional wire hooks without eyelets may be received in the recess 276 and secured to the accessory 270 by soldering, braising, or adhesives.

Referring now to FIGS. 15 and 16, fishing accessories are shown and are generally indicated by the numerals 280 and 290. The fishing accessories are substantially similar, each including a knotless connecting portion 172 as described above with respect to fishing hook 170. The accessory 290 shown in FIG. 16 includes an eyelet 186 having a radial opening 189 on a side opposite slot 112, which is the reverse of fishing accessory 280. Additionally, fishing accessories 280 and 290 include an enlarged portion 282 of body 114 and a bore 284 through the enlarged portion 282. The bore 284 may be used to connect a variety of existing and traditional tackle, such as, for example, leader lines, clips, and split rings.

Referring to FIGS. 17 and 18, fishing accessories are shown and are generally indicated by the numerals 300 and 310. The fishing accessories 300 and 310 are substantially similar, except for having reversed eyelets 186 and radial openings 189, as discussed above with respect to accessories 280 and 290. Fishing accessories 300 and 310 each include a knotless connecting portion 172, as described above with respect to fishing hook 170, a pair of opposing projections 302 and 304 extending from a lower portion of body 114, a neck 306 extending below the projections, and a pair of opposing shoulders 308, 309 at an end of the neck 306. The projections 302, 304, neck 306, and shoulders 308, 309 are adapted to accept hollow ball chain spheres or to create a ball and socket swivel connection for the fishing line.

Referring now to FIG. 19, a fishing accessory is shown and is generally indicated by the numeral 320. Fishing accessory 320 is similar to fishing accessory 280 discussed above and includes a knotless connecting portion 172, an enlarged portion 322 of body 114, and a bore 324 through enlarged portion 322. Fishing accessory 320 also includes a slot 326 extending longitudinally along body 114 from bore 324 to an upper edge 327. The slot 326 forms a first half 328 of accessory 320, and a second half 329 of accessory 320. The first and second halves 328 and 329 may be movable relative to one another to create an opening at slot 326. Projections 330 may be provided on one half 328 or 329 of body 114, and corresponding recesses 332 may be provided on the other half. The projections 330 and corresponding recesses 332 may assure proper alignment of the two halves. An additional accessory or attachment may be threaded through bore 324 by virtue of the open slot 326. Securing a line to the knotless connecting portion 172, as discussed above, acts to secure the first and second halves of accessory 320 together, thereby securing the additional accessory or attachment within bore 324.

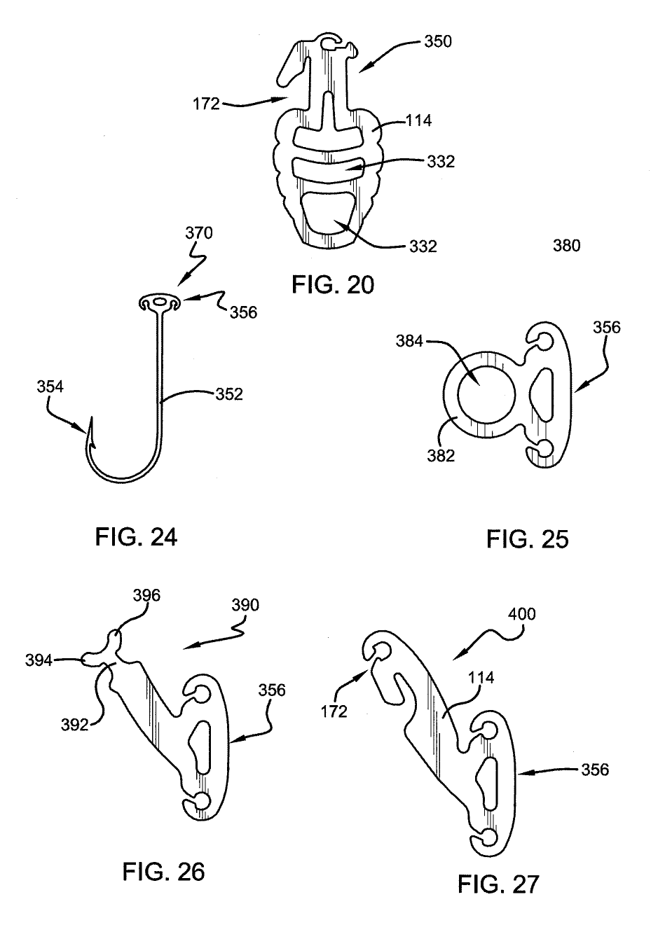

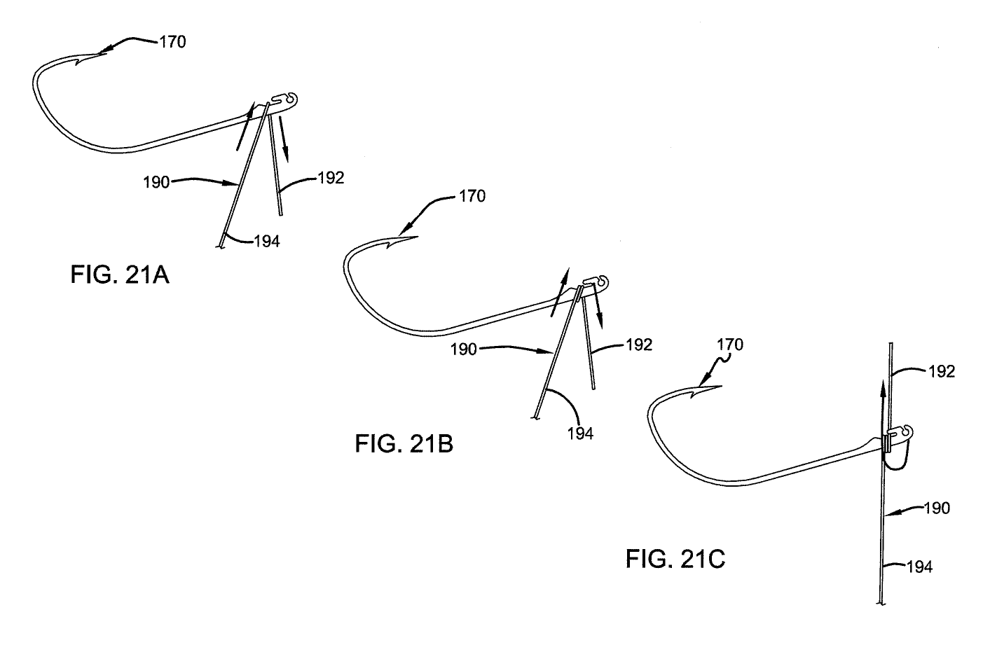

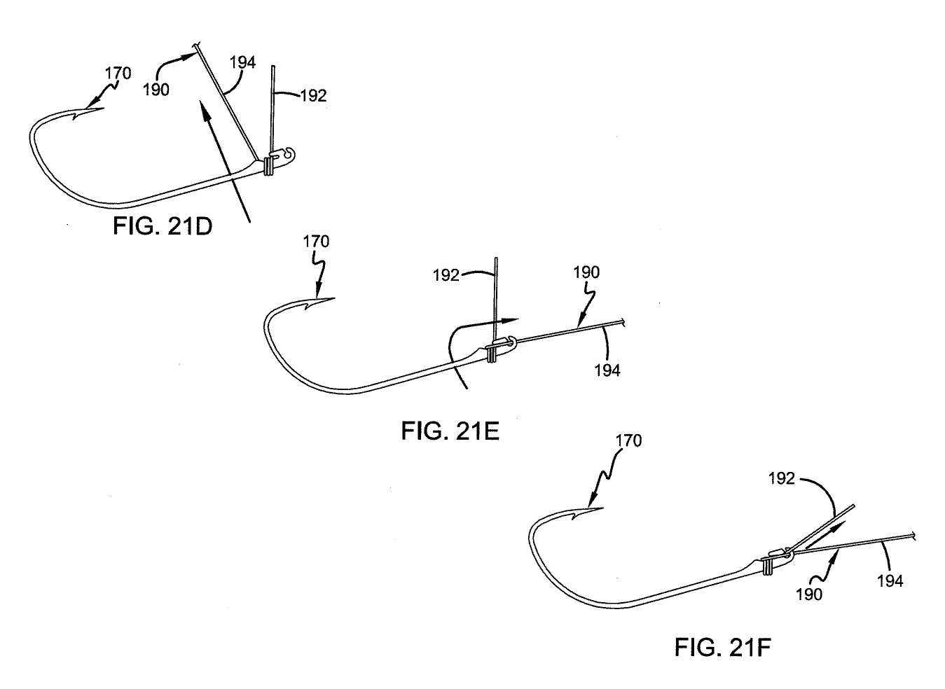

Referring to FIG. 20, another embodiment of a fishing accessory is shown, and is indicated generally by the numeral 330. Fishing accessory 330 includes a knotless connecting portion 172, as discussed above with respect to fishing hook 170. The accessory 330 is a drop shot weight, and in certain embodiments may include a body 114 designed to look generally like a grenade. The body 114 of the accessory 330 may optionally include a number of openings 332 to alter the weight of the accessory, as needed.

FIG. 22 shows an alternate embodiment of a fishing hook, generally indicated by the numeral 350. Fishing hook 350 includes a shaft 352, a hook 354, and a midline knotless connecting portion 356 in place of the knotless connecting portion 172 discussed above. The midline knotless connecting portion 356 includes an enlarged end portion 358 opposite the hook 354. First and second hook portions 359 and 360 extend from opposite sides of the enlarged end portion 358. An opening 362 is provided through the enlarged end portion 358. A line 364 is connected at a midpoint to the midline knotless connection portion 356.

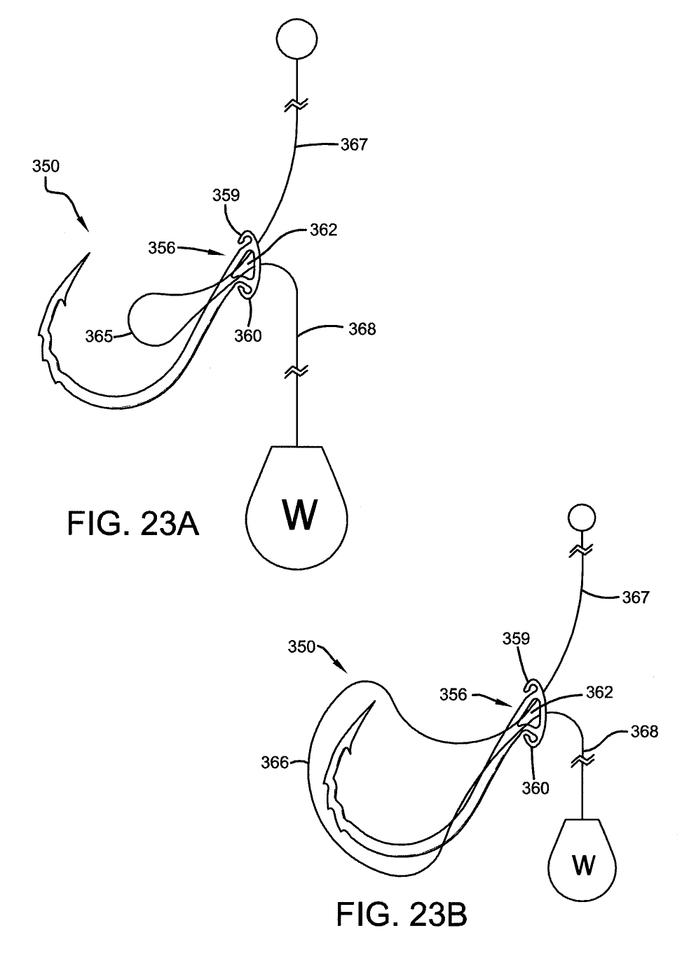

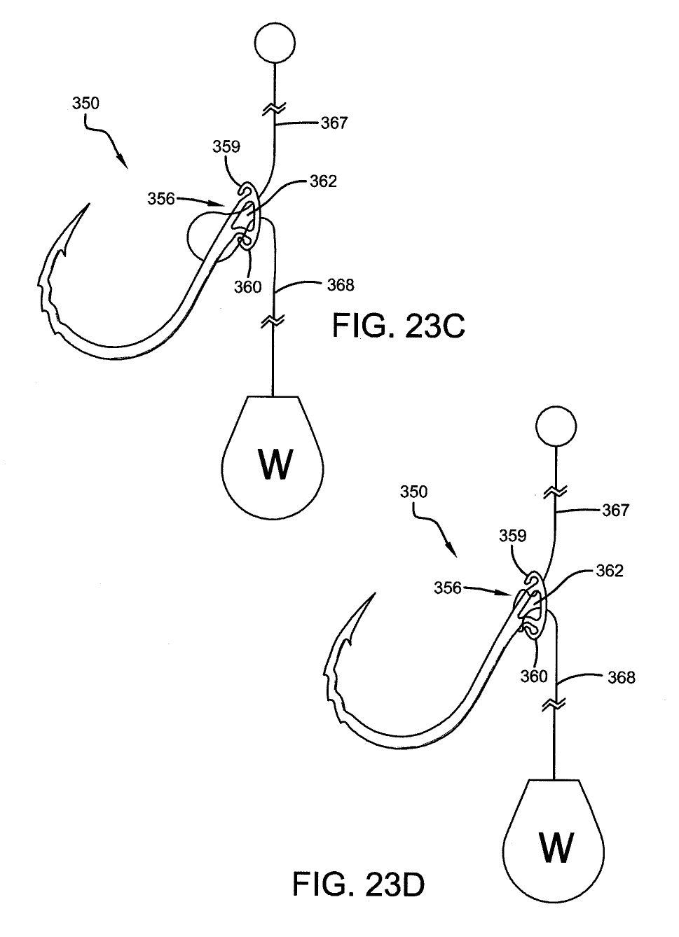

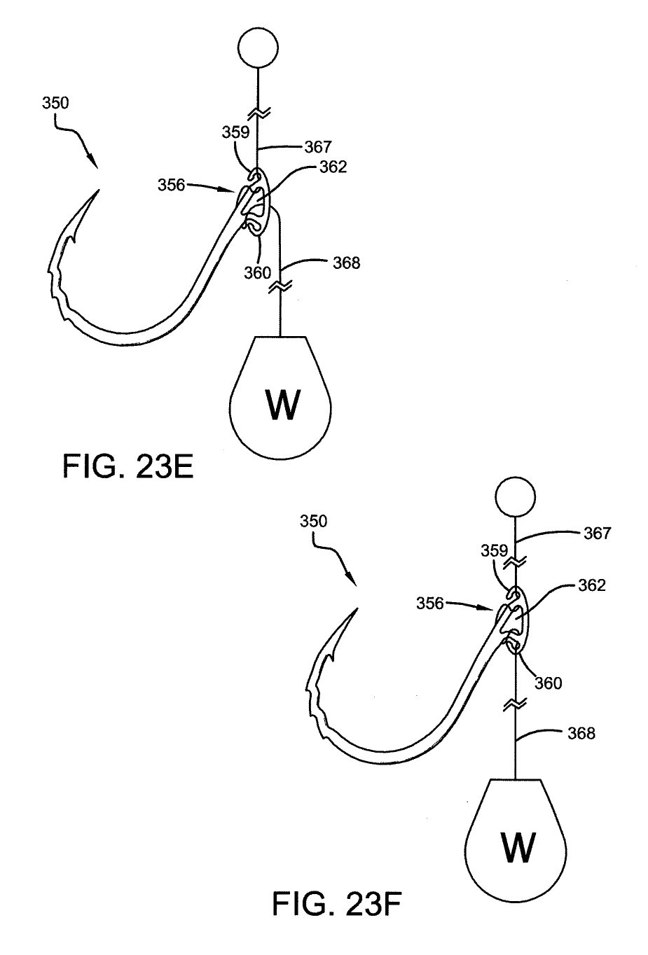

FIGS. 23A-F show the sequence of steps necessary to secure the line 364 to the fishing hook 350. The line 364 is first pinched to create a loop 365, which is inserted from back to front through the opening 362 in the enlarged end portion 358 (FIG. 23A). The loop 365 is then enlarged to form a large loop 366, which is looped around the hook shaft 352 and hook 354 from front to back (FIG. 23B). The large loop 366 is then positioned around the enlarged end portion 358 and tightened slightly to reduce the size of the large loop 366 (FIGS. 23C and 23D). Because the fishing hook 350 is secured to a middle of the line, a primary portion 367of the line 364 extends from the fishing hook back toward a fishing pole and a secondary portion 368 of the line extends beyond the fishing hook and may have a weight (W), another fishing hook, or other tackle secured thereto. The primary portion of the line 367 is then pulled between the first hook 359 and the enlarged end portion 358 from back to front, and is effectively “hooked” into the first hook (FIG. 23E). Similarly, the second portion of the line 368 is also pulled between the second hook 360 and the enlarged end portion 358 from back to front, and is then also “hooked” into the second hook (FIG. 23F). The primary 367 and secondary 368 portions of the line 364 may then be pulled tight around the midline knotless connecting portion 356 to secure the fishing hook 350 to the line 364 without the use of knots (see FIG. 22A).

As discussed above, corners 102 of the fishing hook 350 create friction points that, under tension, retain the hook in place on the line without the use of knots. The method in which the line is wrapped around the fishing hook 350 creates numerous friction points at the corners 102 of the hook, thereby providing significant frictional resistance against movement of the hook. The fishing hook 350 may be moved up and down the line 364 by “unhooking” the primary and secondary portions 367 and 368 from the first and second hooks 359 and 360, and the hook re-secured by once again hooking the primary and secondary lines into the hooks.

Referring now to FIG. 24, another embodiment of a fishing hook is shown, and is generally indicated by the numeral 370. Fishing hook 370 is substantially similar to fishing hook 350, and like components are numbered accordingly. Fishing hook 370 includes a shaft 352, a hook 354, and a midline knotless connecting portion 356. The midline knotless connecting portion 356 of fishing hook 370 is positioned at the top of a generally linear shaft 352, and is oriented generally perpendicular to the shaft 352. This orientation of the midline knotless connecting portion 356 holds the hook 370 at a desired angle relative to the line, and is much simpler and easier to use than conventional alternatives.

FIG. 25 depicts an alternate embodiment of a fishing accessory, generally indicated by the numeral 380. Fishing accessory 380 includes a midline knotless connecting portion 356, as discussed above, and an enlarged portion 382 having a bore 384 therethrough. The bore 384 provides a universal attachment point for other devices or tackle, such as, for example, a trolling line or a clip.

Referring to FIG. 26, another embodiment of a fishing accessory is shown, and is generally indicated by the numeral 390. Fishing accessory 390 is similar to fishing accessory 380, and includes a midline knotless connecting portion 356, as discussed above. Accessory 390 also includes a neck 392 at an end of the body 114, and a pair of opposed shoulders 394 and 396 extending in opposite directions from an end of neck 392. Similar to the fishing accessories shown in FIGS. 17 and 18 and described above, the neck 392, shoulders 394 and 396 are adapted to accept hollow ball chain spheres or to create a ball and socket swivel connection for the fishing line.

FIG. 27 depicts another embodiment of a fishing accessory, generally indicated by the numeral 400. Fishing accessory 400 includes both a knotless connecting portion 172, as discussed above with respect to fishing hook 170, and a midline knotless connecting portion 356, as discussed above with respect to fishing hook 350. Thus, the accessory 400 can be secured at a midline location by virtue of the midline knotless connecting portion 356, and another line may be secured to the knotless connecting portion 172. In certain embodiments, the body 114 of the accessory 400 extending between the midline connecting portion 356 and the connecting portion 172 may be oriented on an angle. Fishing accessory 400 allows for knotless connection of the accessory to a midpoint of a line by virtue of the midline knotless connection portion 356, and for the knotless connection of another accessory, such as, for example, a trolling line or other tackle by virtue of the knotless connection portion 172.

It is thus evident that knotless connecting members and methods of forming knotless connections as described herein substantially improves the art. Only particular embodiment(s) have been presented and described in detail, and the invention should not be limited by the drawings or the description provided. For an appreciation of the true scope and breadth of the invention, reference should be made only to the following claims.

1. A knotless connection assembly comprising:
(a) a connector having a body including a plurality of generally planar surfaces intersecting at a plurality of corners; and
(b) a line connected to the connector without the use of knots, the line including a tail end wrapped around said body to form a wrapped portion of the tail end, and a primary line overlapping at least part of the wrapped portion of the tail end.

2. The knotless connection assembly of claim 1, said connector further comprising a slot in said body for receiving a portion of the line connected to the connector, the slot including a closed end and an open end.

3. The knotless connection assembly of claim 2, wherein said slot progressively decreases in width from said open end to said closed end.

4. The knotless connection assembly of claim 3, wherein said slot has a depth D that is greater than two times the diameter of the line.

5. The knotless connection assembly of claim 2, further comprising a second slot in said body, and a second line connected to the connector without the use of knots, the second line including a tail end wrapped around said body adjacent to said second slot to form a wrapped portion of the tail end, and a primary line overlapping at least part of the wrapped portion of the tail end of the second line.

6. The knotless connection assembly of claim 2, further comprising an eyelet positioned adjacent to said slot, said eyelet including a bore and a radial opening providing access to said bore, said primary line passing through said bore.

7. The knotless connection assembly of claim 6, where an end of said tail portion passes through said bore in said eyelet.

8. The knotless connection assembly of claim 6, where said connector is part of a fishing hook, the fishing hook including a shaft and a hook portion, the connector being positioned at an end of the shaft opposite the hook.

9. The knotless connection assembly of claim 1, the connector further comprising a bore for attachment of other objects to the connector.

10. The knotless connection assembly of claim 1, the connector further comprising a slot for receipt and attachment of other objects.

11. The knotless connection assembly of claim 1, said connector including a central shaft, a notch in each end of said shaft, a pair of arms extending laterally outwardly from each end of said shaft, the intersection of each arm and said shaft forming a recess, wherein said tail end of said line is wrapped around one end of said shaft and the adjacent arms, and a second line includes a tail end wrapped around the other end of said shaft and the adjacent arms.

12. The knotless connection assembly of claim 1, said connector including a loop end, a bore through said loop end, first and second shafts extending from said loop end and defining a slot therebetween, and an arm extending laterally outwardly from an end of each of said first and second shafts, said tail end of said line being wrapped around the first and second shafts to close said slot.

13. The knotless connection assembly of claim 1, said connector being formed from a flat sheet material having a thickness of less than 0.030 inches.

14. The knotless connection assembly of claim 1, said connector having opposing planar surfaces oriented generally parallel to one another.

15. A fishing hook comprising a knotless connection portion adapted to connect the fishing hook to a fishing line without the use of knots, a shaft, and a hook portion, the knotless connection portion including:
(a) a body that is part of said shaft, said body having top and bottom surfaces oriented generally parallel to one another and side surfaces extending between said top and bottom surfaces to define a thickness of said body;
(b) a slot having an open end and a closed end, and
(c) an eyelet positioned adjacent to said slot, said eyelet having a bore and a radial opening.

16. The fishing hook of claim 13, said body having a thickness of between approximately 0.010 and 0.030 inches.

17. The fishing hook of claim 13, further comprising a fin having an enlarged width along a portion of said shaft.

18. The fishing hook of claim 13, further comprising a prong extending from said shaft adjacent to said knotless connecting portion, said shaft being curved so that said knotless connecting portion is positioned over said hook portion.

19. A method of connecting a fishing hook to a fishing line comprising the steps of:
(a) positioning a fishing hook adjacent to a tail end of a fishing line, the fishing hook having a knotless connecting portion that is generally planar, with a top surface and a bottom surface oriented generally parallel to one another;
(b) wrapping the tail end of the fishing line around the knotless connecting portion of the fishing hook to form a wrapped portion of the fishing line; and
(c) wrapping a primary line that extends back to the fishing rod over the wrapped portion of the fishing line.

20. The method of claim 19, further comprising routing the primary line through a slot in the knotless connecting portion and through a bore in an eyelet positioned adjacent to the slot.
